(19) United States
(12) Patent Application Publication
(10) Pub. No.: US 2019/0066607 A1
(43) Pub. Date: Feb. 28, 2019

(54) Visual Representation of Electromagnetic Signals Utilizing Controlled Electrostatic and Electromagnetic Vibration Energy within Transparent Conductive Enclosures

(71) Applicant: Soweto Abijah Mitchell, Hollywood, FL (US)

(72) Inventor: Soweto Abijah Mitchell, Hollywood, FL (US)

(21) Appl. No.: 15/686,328

(22) Filed: Aug. 25, 2017

(51) Int. Cl. G09G 3/34; G09G 3/00

(52) U.S. Cl. CPC G09G 3/3433; G10H 3/12; G09G 2300/0469; G09G 3/003

(57) ABSTRACT

An apparatus and a method to facilitate the visual representation of electromagnetic signals, both audible and inaudible, which preferably is comprised of a component for realistically reproducing sound, if any, and necessarily is comprised of one or more components for producing a visual display which is influenced by inputted electromagnetic signals. This is achieved utilizing a high voltage/low current electrostatic source (charged above 10 kV) to electrostatically charge and discharge one or more display cases containing lightweight micro-spheres or objects of any shape or size capable of being influenced by electrostatic energy. This is demonstrated when the charged light-weight objects jump up, down and in all other directions in a fully transparent display to the rhythm of the music or other audio if any is present or reflecting the amplitude, intensity and frequency fluctuations of more random signals using pulsed, controlled electrostatic discharges. These characteristics are also shown by light displays which sway and waver with the electrostatic discharges and which flash with various signal changes. These characteristics are further demonstrated by micro-bead substrate changes which occur with vibrations of a transparent vibration plate. Various lenses, mirrors and even the lights within the system can also be made to move with the signal using the method described by this invention to change, light strip position, light reflection angles, focal points and magnification. Furthermore reflections of lights and the moving objects in the transparent electrostatic display enclosures are projected in a three dimensional visualization above the top display window of the apparatus utilizing fresnel lenses and a reflective mirror system as they move and sway, their movements, undulations, and reflections are projected and magnified, along with the movements of the objects for the viewer/user's entertainment. Achieving these results involves a method of making electrically conductive sheets and apparatus layers which are almost completely transparent so as to not impede the passage of light through the apparatus, also utilization of a transparent vibration plate and micro-beads with desired properties.

### FIELD OF INVENTION

The present invention relates to arrangements for making visible or audible the words spoken. Specifically describing a means of radiating and simultaneously displaying combined wave patterns and other characteristics of both audible and inaudible signals, especially resonant standing wave nodes, antinodes, amplitude, rhythm and frequency changes in a dynamic, three dimensional visualization system of light, object and particulate displays utilizing electromechanical vibration energy, light and electrostatic energy controlled by an input signal.

### BACKGROUND OF INVENTION

The use of speaker systems has been a long standing method of listening to audio in all formats. Many people also use light displays with mostly LEDs and lasers which flash to the changing tones of the audio or rhythm of the music being played especially in homes, nightclubs or enclosed in vehicle based speaker box systems. Some other variations in light patterns, e.g. LED equalizers on home stereos and other related methods have also been utilized in home receiver and audio amplifier setups to display sound volume changes in various frequency ranges. Electromagnetic signals of different frequencies, in general, can also be displayed using Oscilloscopes and Spectrum Analyzers which can even display different phases of each signal and can display their waveforms or spectral density and distribution in 3 dimensional renditions on 2D LCD displays or computer monitors. Cymatic devices such as the Cymascope show standing waves of tones and frequencies.

Another approach to displaying electromagnetic signals in general and audible sound waves in particular, is to show them physically, using solid matter as opposed to virtually on a display. The Chladni plate and other similar inventions like the Tonoscope were introduced to show sound using particulate matter but only very slowly and only if the frequencies are very defined and transitions are very clear. The shortfall of all these methods and systems is that they don't display the sound in a three dimensional real world space and they don't display sounds in real time as they might be played in a multi-chord, multi-instrument song, for example. They don't easily allow other methods of physically displaying signals to be incorporated because they are generally self contained systems in typically non transparent configurations. Various substrates have been utilized with vibration Chladni plates but the use of transparent vibration plates and/or transparent electrostatic charge/discharge surfaces and enclosures which allow mirrors and fresnel lenses to be incorporated into the design, becomes necessary for light to pass through in order to produce a visually stunning 3D holographic effect and combined with the movements of objects, micro-beads and lights an improved way of viewing or perceiving electromagnetic signals is produced.

Newer technologies utilizing a network of individually controlled transducers outputting ultrasonic frequencies to suspend or move objects or liquids aim at location specificity and phase modulation algorithms to control object movement. These methods while capable of producing volumetric 3D displays which move objects pixel by pixel or location by location are slow, complex and not designed as consumer entertainment devices which reproduce and display signal patterns esp. sound, whereas this invention seeks to move objects, using electrostatic forces, to match any user inputted signal in order to show the signal itself, whether audible or not, instead of to show an image or moving image with preprogrammed pixel locations, as well as, allow the user to hear the signal simultaneously if desired.

Frequency characteristics and transitions of the signal are demonstrated by this apparatus utilizing exciters/transducers/vibration speakers and a transparent “vibration” plate connected to the speaker's electromagnetically movable coil to transfer electromagnetic vibration energy from the speaker coil to the vibration plate, which consequently creates ripples and standing waves in the flat plate, which then act upon the substrate of micro-beads placed upon the plate, thereby demonstrating the actual geometric structures of the changing and fluctuating signal frequencies, including standing waves and especially their transitions, with patterns of changing nodes and anti-nodes displayed in real time.

The movements of the objects in this invention are determined by signal changes, the charge affinity of the materials chosen and the semi-random nature of the charge transferences created by these objects sometimes randomly bouncing off the sides of the display enclosures as they charge and discharge on the electrostatically conductive faces of the enclosures. In this way more natural, rhythmic and faster movement is created since electrostatic energy acts upon these objects with more electromotive force than ultrasonic sound pressure waves. Some newer technologies use ultrasonic signal phase changes between transducers to help move objects whereas this invention utilizes opposite signal phases to facilitate noise cancellation functions only. However, signal phase changes and changes in the sequence or intensity of electrostatic discharges may be employed to better control object movement in other embodiments.

### SUMMARY OF THE INVENTION

By combining a particulate and object display method which utilizes transparent conductive layers and using electrostatic energy from high voltage step-up transformers through these layers of connected transparent plates to partially suspend and or move laterally, longitudinally or otherwise little objects or even beads in a 3D transparent box, allowing the electrostatic discharges to freely act on these objects in some way reminiscent of the input signal changes of audio or any other electromagnetic signal. Depending on whether electromechanical vibration/pressure wave energy or electrostatic energy, is allowed to act on these objects, in other words, which display layer of the apparatus is viewed, then the manner in which sound is displayed changes, in one sense from a horizontal display plane to a vertical one. The transparent vibration plate displays changes in horizontal and the electrostatic enclosures display mainly in the vertical plane, for example. At the same time a light display projected three dimensionally above the glass panel at the top of the device enhances the visualized perception of the sound being heard or signal being inputted by the listener/viewer.

A vibration speaker or transducer is connected to the flat plate of moderately to highly bendable/flexible plastic, polycarbonate or other flexible, transparent materials via a rigid connector bonded to the speaker voice coil/cone and affixed to the plate whereby vibration energy is transferred from the voice coil and distributed through the transparent plate. This allows the formations of traveling, standing and combining waves with their nodes and antinodes which change with the corresponding audio tones and/or signal frequencies. Once these waves travel through the plate and into the surrounding air and particulate micro-beads nearby then the electromagnetic energies produced push and pull the particulate beads into geometric patterns reflective of the particular frequencies or tones being radiated but in real time with user content controlled from a smart device wirelessly or any other connection method.

On one level, high-voltage, low current, ionizing static electricity is applied in certain instances to a conductive but transparent glass, acrylic, polycarbonate, or plastic plate below the micro-beads which are comprised of charge accepting and preferably reflective, neon, glittery or glossy coated surfaces. These beads gain higher mobility with the influence of the electrostatic charges but are mostly moved by the vibration speaker's pressure waves flowing through the vibration plate so they are more easily manipulated by the changing sound waves. The longitudinal waves from the speaker move the particulate or microbead substrate on the horizontal axis and the particles remain enclosed in a circular, elliptical, rectangular or other shaped transparent wall made of polycarbonate or other transparent materials. The particulate beads, e.g. amaranth seeds, also stay close to the center of the plate due to a small concavity of the plate so with this concavity and the wall around the beads they are prevented from drifting to the edges of the plate. Lower frequencies can be played at higher volumes to level out the substrate or a blower fan vacuum system can also be employed. Frequency selective circuitry similar to audio crossovers is utilized to send only particular frequency ranges to the vibration plate since some frequency ranges produce better cymatic displays than others. More discrete frequency selection is accomplished using a network of RC low and high pass filters or DSP through a PLD like an Arduino to only allow as close to fundamental frequencies as possible to pass through the vibration plate.

On another transparent level or layer of the device, high-voltage, low current, ionizing static electricity is applied in pulses matching the sound/signal waves to a conductive but fully transparent glass, acrylic, polycarbonate, or plastic plates, forming an enclosure above, below and to the sides of micro-spheres and small objects which are comprised of charge accepting and possibly reflective or glossy coated surfaces, e.g polystyrene plain or coated with conductive paint or stannous chloride, for example. These are excited in their enclosure and manipulated by the changing pulses of static electricity matched to the sound waves. While the longitudinal waves from the speaker move particulate beads on the horizontal axis, the pulses of static electricity move them on the vertical axis thus rendering a three dimensional reflection of the sound waves as if they were passing through the particulate enclosure. When a positive charge is applied to the plate the beads are drawn to it then repelled from it when a negative charge is applied. These charges are modulated and pulsated in synch with the sound waves or other signals being played from an input source.

The glass or high-temperature-tolerable polycarbonate plate can be made conductive via a method utilizing a solution of Sn2Cl (tin chloride), ammonium biflouride, diluted hydrochloric acid, or any other conductive substance to dope the surface of the glass or polycarbonate and which may be doped in the process of manufacturing. Wires to transfer HV can be connected with conductive paint or similar conductive bonding agent. A better method was developed, as described in Claim 7, involving the use of an electrolyte between 2 thin transparent plates, whether doped or not, which renders both sides conductive particularly for high voltage/low current static electric or ionizing energy.

A separate glass or polycarbonate plate or sandwiched conductive layer forms the top of each enclosure holding the beads or objects and a large plastic, acrylic, glass, polycarbonate or similar conductive plate may form the bottom of the particulate enclosures. Each enclosure may also have individual top and bottom conductive plates or an array of conductive plates for better electrostatic control in order to produce better or more entertaining or otherwise useful movement.

Beneath the transparent particulate enclosure and transparent vibration plate is a highly reflective standard mirror with fresnel lens on or above its surface and above the enclosures is a LED strip and above that a possible one-way mirror, used to enhance the reflections of light. If the one-way mirror is utilized at the top then the mirror assemblies and fresnel lens layout above and below the vibration plate and particulate enclosure create an improved “infinity mirror” type of display as the LED lights bounce between the 2 mirrors and all the reflections created by the interplay between the light and the movements of the fresnel lenses and reflective particulate beads are reflected and refracted many times over which happens to a lesser extent even without using a one way mirror as the top apparatus display window. The configuration described by the invention creates a light display pattern which pulses and undulates with the sound waves from the audio/signalsource along with objects and particulate or microbead substrate doing the same.

The present invention addresses the shortfalls with traditional speaker systems capable of displaying sound/frequency patterns using LED lights, LCD displays or monitors while providing high audio fidelity and sound quality.

An advantage of the invention is that audio signals are displayed in 4 different ways within one easily viewable display system. Micro-beads or other objects display sounds through longitudinal sound pressure waves and electrostatic energy, micro-spheres or beads display sound amplitude and low frequency with the rhythmically bouncing spheres, LED lights display sound by flashing and also 3D projections of light sway in conjunction with certain selected frequencies. This is all in conjunction with hearing high quality audio which correlates to the visual display giving the user/listener/viewer a unique and new experience.

Another advantage of the invention is that it is functional as a piece of furniture or display art such as a lighted display case with or without audio or it can be used just as a speaker system when no display is needed or as both. This system can either have legs to stand on or be placed on top of existing furniture like a table or shelf or suspended to support its weight.

An advantage of the stand arrangement is that the device settles under its own weight to the optimum level position, so that external disturbances and any tilting can automatically be compensated for.

In a preferred embodiment, a mirror with possible dimensions 14″×20″ is placed inside at the base of a rectangular wooden box, with possible dimensions 15″×21″ which will serve as the display enclosure and speaker box. This mirror can be affixed with an adhesive such as epoxy resin which hardens and allows sound waves to be transmitted from the glass plate into the wood to produce a deeper, less metallic sound than just the mirror alone. A single rectangular fresnel lens of similar size is placed on top of the mirror or a combination of any number of smaller fresnel lenses can be arranged in a pattern, e.g, in one embodiment 4 individual lenses measuring 7″×10″ placed in a 2×2 grid can be utilized to produce a 3d-like, zoomed holographic projection of whatever is reflected by the mirror, the more lenses used the more reflections and holograms are produced.

The lens(es) can be affixed to the mirror using a transparent adhesive or glue at its edges or, as in this embodiment, 4 rectangular lenses are placed 2 inches above the mirror, mounted on swivel bearings which allow the lenses to swivel or partially rotate up and down moving in the vertical plane from about 0 to −30 degrees if the horizontal x-axis is considered 0 degree. To accomplish this, a rod serving as axle for the bearing is connected perpendicularly at the center along the length-side of each lens and connected with the rod facing toward the outer edges of the apparatus along its length also. The bearings are attached into the sides of the rectangular apparatus at approx 5″ and 15″ along both length sides at a height of approx 2″ above the mirror. At each width side of the apparatus placed approx 1″ above the mirror underneath each of the 4 fresnel lenses are placed 4 transparent conductive plates with dimensions 8″×2″ connected to the electrostatic sources. A conductive tape/strip is placed covering 1″ of the lenses at each width side and where the lenses are positioned to have their conductive strip directly above the conductive plates. When electrostatic energy is applied to the strip and the conductive plates below them the electromotive forces created move the lenses up and down on their swivels about the vertical plane. These movements are reminiscent of the input signal driving the electrostatic generators and cause light reflection changes and focal length changes which change the reflections through the lenses to somewhat match some of the changes in the input signal. Causing light to seemingly undulate or vibrate to the input and causing the holographic projections of objects and light to be distorted, enlarged and reduced based on the control signal.

Transparent rectangular cubes with conductive faces are connected electrostatic sources with wires in contact with an electrolyte placed in-between the double-plated transparent faces of each enclosure which contain objects and micro-spheres which move utilizing the electromotive or Coulomb force, or more specifically Coulomb Interactions controlled by the input signal. Utilizing a high voltage/low current electrostatic source to electrostatically charge and discharge one or more display cases containing lightweight micro-spheres or objects which may be of any shape. This is demonstrated when the charged light-weight objects jump up, down and in all other directions in a fully transparent display to the rhythm of the music or other audio if any is present or reflecting the intensity and fluctuations of more random signals using pulsed, controlled electrostatic discharges. The High Voltage sources used generated over 80 kV using low current( <10 mA) and were cycled on and off by circuitry controlled by the input electromagnetic signal. This signal is loaded into memory and reproduced by a IC controlled sound module via bluetooth or WiFi, amplified and run through low pass filters for cycling the HV sources with frequencies lower than 500 Hz as with, for example, the drum and kick instruments in music. With audio/music one enclosure handles left channel low frequency with larger objects and another left channel mid-low frequency with smaller objects. A 2×2 grid of electrostatic enclosures also represents the left and right channel of audio in this manner.

At the inside edges of the wooden box or edges of the tops of the electrostatic object enclosures (if sides of enclosure are also transparent) can be affixed 4 to 8 equidistantly spaced springs which will serve as a support for the vibration plate layer which will be 3.5 to 4″ above the enclosures(to accommodate for the focal distance of the fresnel lens). The transparent vibration plate can also be placed on top of rigid posts instead of springs but vibrational energy seems to radiate through the transparent plate better with springs at the corners. Above the enclosures, placed at its center, will be affixed a vibration speaker which will be In-between the mirror and the vibration plate which is attached to the vibration speaker itself and supported by the springs on the box edges. The vibration plate will freely vibrate inside the space of the speaker box without obstruction but only supported and connected to the vibration speaker at its center and the springs at its edges. The vibration plate will also have an enclosure to stop escape of the micro-beads.

Preferably, the transparent vibration plate is bonded or glued to a hard plastic or metal sound post connected to the speaker coil and connecting it to the vibrating plate from below at its center. Application of electrical signals to the speaker coil causes movement in the plastic plate and equal and opposite movements in the springs and thus the edge of the glass plate. This push-pull action causes pressure waves ito flow through the vibration plate.

Preferably, additional springs are placed on top of the vibration plate to support a lightweight rectangular or any geometrically shaped support for an LED strip which will hover above the vibration plate at about possibly 3.5″ to 4″ and 7″ to 8″ above the mirror. The LED strip is supported only by the springs connected to the vibration plate, thereby transferring pressure waves and vibration energy from the speaker system through the vibration plate to the LED support. This causes the lights to waver, sway and bounce with the sound/pressure waves produced by the speaker (in addition to the movements created by electrostatic forces also acting upon the LED strips).

Preferably, micro-beads, doped with chemicals such as stannous chloride to render them more charge-accepting micro-spheres, can be made of polystyrene or any other material which is light, capable of holding a charge or movable by sound vibration waves or electrostatic forces (Coulomb interactions), are placed on top of the vibration plate in their own transparent rectangular or any shaped enclosure containing a conductive transparent top surface which is charged up to ionizing voltages with low current. This enclosure contains the micro-beads in the intended display area on the transparent plate, possibly 10″×15″ but any size. The high voltage electrostatic field applied to the glass plate stimulates the micro-beads and re-centers them while also exciting them to a higher potential voltage rendering them more easily moved by the sound/pressure waves.

Preferably, the static electric field applied to the glass plate and micro-beads within the enclosure will pulse on and off modulated by a tuned frequency response from the input signal being played from the source and by the speaker. Utilizing pulse width modulation (PWM), RC and LC frequency filters/crossover circuits, various amplifiers, step up transformers and other methods described herein to produce high voltage pulses, selectively controlled by pulses of particular frequencies in the audio signal.

Preferably differential amplifiers with feedback loops connected to one or more microphones in the sealed vibration plate micro-bead enclosure and static electricity object enclosures are used. Microphones capture sounds of bead and object movements and collisions which can be desirable for the musical instrument qualities of the apparatus, but the noises from which can be reduced or eliminated with the differential amplifier comparing the original input signal with the input+noise signal captured by the microphones. The methodology of first reversing the phase of the input signal, as described in the flowchart of FIG. 5, before it is fed into the vibration plate's speaker and electrostatic control circuitry to help reduce noise within the system is also utilized.

Preferably, amplifiers are utilized, differential or otherwise, which have output characteristics matched to the characteristics of the speakers and transducers/exciters and which also amplify the frequency ranges which are easier displayed in this micro-bead substrate (e.g fundamental frequencies of musical notes) and which also regulates the volume/amplitude levels of each frequency range to balance output levels with functioning auto gain control with negative or positive feedback. Different frequency ranges produce lesser and greater movement of the micro-beads within the micro-bead substrate. Frequency selective/limiting circuitry, e.g. a bandpass filter network, and/or digital signal processing and programmable logic are utilized to better synchronize all visual displays to particular intsruments, particular tones, or particular frequencies with visually geometric or otherwise distinct cymatic patterns.

Preferably, sound absorbing materials are used to reduce the sound emanating from the section where the micro-beads and objects create patterns due to the aforementioned collisions of these items interfering with sound quality of some audio and music. These areas can be sealed to helped reduce some noise. More unwanted noise can be blocked using sound insulation around the sides to eliminate more than noise cancellation circuitry alone. One simple method utilized to reduce unwanted noise was to connect the vibration speaker/transducer connected to the vibration plate in opposite phase to all the other vibration and traditional speakers in the device so that they may cancel out and drown out some of the unwanted sounds and harmonics. These measures help reduce the amount of airborne sound in the speaker enclosure and makes dampening the sounds easier.

Preferably, there are at least two primary traditional speakers and two or more vibration transducers also, where one is connected to the vibration plate and the other(s) to the speaker system housing. Also speakers can be pointed in 2 or more directions to create spatially diverse sound.

### BRIEF DESCRIPTION OF THE DRAWINGS

Other objects, features and advantages will occur to those skilled in the art from the following description of preferred embodiments and the accompanying drawings, in which:

FIG. 1 is an open side view of the apparatus with relevant layers.

FIG. 2 is a view of the base of FIG. 1 showing one potential placement of non vibration speakers in the apparatus.

FIG. 3 is a view of light from above reflecting off the mirror and back up and through the fresnel lenses and above the object static enclosure where the objects are reflected holographically around the focal point of the lenses

FIG. 4 is an overhead view of the apparatus showing all layers starting from above with the top transparent display through which is viewable the transparent vibration plate/cymatic geometric patterns layer (patterns left out for clarity but examples shown in FIG. 6 and FIG. 7), then the electrostatic object enclosure layers then the fresnel lenses and mirror at the bottom. LED strips are reflected and projected as arches holographically which sway and move above the enclosures and also lights flash and reflect in too many angles to accurately illustrate.

FIG. 5 is a flowchart showing the system architecture of the apparatus.

FIG. 6 shows an example of a geometric cymatic display pattern for a particular frequency as seen through the top display window and on the transparent vibration plate layer of the apparatus.

FIG. 7 shows another example of a geometric cymatic display pattern for a combining or transitioning frequency as seen on the transparent vibration plate layer of the apparatus.

### DESCRIPTION OF THE PREFERRED EMBODIMENTS

This invention can be used as an audio receiver, speaker system, audio visual display, as a piece of display art, musical instrument or any combination of these applications where most functions of this apparatus including what audio or signal to input, intensity of display and light color/pattern selections can be controlled from a mobile device or computer via bluetooth or wifi or any other system which allows for similar connectivity. This invention can also be used as a scientific display apparatus which allows the viewer to specifically see not only the effects of sound waves and other electromagnetic signals on physical matter and the general cymatic geometry of soundwaves, thereby viewing the frequency response of a particular input signal but also the signal amplitude, rhythm and tempo using the effects of controlled static electricity, electromechanical vibrational energy on physical matter and the correlation and interplay between energy, light and matter in general. This invention may also serve useful in various other ways, involving controlling and displaying light, static energy, vibration and pressure wave energy controlled by a signal which may be modulated (pulsewidth or otherwise), for those skilled in the art.

For this invention or any utilizing some or all of the principles listed in the claims, the materials chosen depend mainly on the static electric permittivity, e.g. dielectric constant of the transparent conductive plates, the charge carrying potential and electron mobility of the electrolyte inside these plates, the vibrational conductivity and flexibility of the material used for the vibration plate, the fluid dynamics and mobility of the particles chosen for the vibration plate substrate chosen with great care to demonstrate electromagnetic wave changes as fast as possible; the measured and proportional conductivity of the surfaces of object/micro-sphere enclosure and the chemical doping of the objects/micro-spheres carefully balancing the lightness and charge accepting ability of these objects; the oherge accepting materials used to make the led strip and fresnel lens; the quality, positioning orientation and phase of speakers and transducers; also the noise canceling and frequency selectiveness of audio amplifier/crossover and general acoustic qualities of the wood chosen to complete the audio visual display and speaker system.

This invention uses conductive plates with 2 sandwiched individual transparent thin glass or acrylic plates with an electrolyte between them. In other embodiments 2 individual polystyrene or 2 individual polycarbonate or 2 glass or 1 glass and 1 polystyrene or 1 glass and 1 polycarbonate are also used, each with different dielectric and charge carrying/storage capacities. The plates are affixed and sealed together around the edges using transparent water tight epoxy. In one embodiment glow in the dark pigments are mixed with the epoxy to create glow in the dark lines which enhance the display and quinine is used in the electrolyte which makes it glow under UV light. An electrode is connected via a plurality of methods depending on the electrolyte chosen and an electrical connection is made between the electrolyte and the outside circuitry of the invention via an inserted electrode which is also sealed off with epoxy to prevent electrolyte leaks.

The electrolytes chosen included ionized water, acids such as hydrochloric and hydroflouric, stannous chloride, methyl, ethyl and various combinations of these electrolytes, all diluted to safe levels based on the electrical conditions and potentials for slightly elevated heat present. Various quantities were also tried and typically ⅓ hydroflouric acid, ⅓ stannous chloride and ⅓ water produced acceptable performance as a function of cost.

In one embodiment this system is comprised of a wooden box enclosed on the bottom and sides with a glass or polycarbonate transparent cover. In a preferred embodiment only the base is wooden or a composite of materials and all other faces of the apparatus are transparent. At the base of this box is a mirror which covers most or all of its base. The quality of this mirror and the fresnel lenses placed a few inches above it are important to produce quality seemingly realistic 3D projected reflections when objects from above are reflected by the mirror, through the fresnel lens as holograms which seem to float above, below, or beside the objects themselves. The enclosures containing the doped objects/spheres above the fresnel lenses and mirror are placed at a particular height, such that, they are enlarged and projected above the enclosure and even the top display panel itself with the aforementioned 3D projection/reflection created by the fresnel lens and mirror. The movement of these objects, vertically or otherwise, are displayed to the viewer while the objects appear to enlarge and diminish in size as they bounce around in the enclosure and give the illusion that they are moving a lot closer and further away from the viewer than they actually are as they move with the rhythm, tempo and intensity of the input signal.

In this embodiment there are 4 enclosures with different sized objects and micro-spheres which move at different speeds and therefore help to display the low and high frequency fluctuations of the signal amplitude. The transparent conductive plates placed above and below these enclosures cause movement of the fresnel lens below them and the LED light strip directly above them surrounding the enclosure. The materials chosen for these 2 components are plastics responsive to high voltage/static electricity moving with the electrostatic pull and push created by the repulsive and attractive forces created by the pulses of static electricity which are driven and modulated by the user controlled signal input. In this embodiment audio and music are the preferred input but any electromagnetic signal can potentially be viewed using the apparatus.

The input signal is sent through a band pass filter circuit as shown in the illustrations, which allow only impulses in particular frequency ranges, especially those below 600 Hz within the bass/kick and drum range for the object displays and 600 to 3000 Hz for the audio visual micro-bead display. The signal frequencies allowed to pass through the filter as pulses drive the switching circuit which are transistor or transistor and relay controlled in different versions of this embodiment but which can be controlled in other ways by those skilled in the art. The high voltage static electric pulses which charge and/or discharge the plates are produced either by step up transformer configurations, e.g those used in an Armstrong Self-Oscillating Voltage Booster or portable ionizer devices.

Above the mirror, the fresnel lenses, the 4 transparent enclosures, the transparent conductive plates and directly above the LED Strip(s) would be the fully transparent cymatic geometry/audio visual display layer with a vibration speaker or transducer, preferably 10 watts or greater, affixed below the vibration plate to produce vibrations in the plate which transfer to the substrate of particulate material on top of the plate to reflect the geometry and changes of the signal or sound waves especially standing wave nodes and anti-node structures. In this embodiment a combination of micro-beads were utilized comprising mostly of amaranth seeds, glass, plastic, polystyrene and/or aluminum pellets, however not limited to these materials, but preferably using pellets below 2000 micron in diameter and with different static attractions or affinity to the materials chosen for the vibration plate based on desired frequency ranges to display.

At the top the display panel there can be a mirror reflective tint affixed to it with its mirrored surface facing inside the box to reflect light being projected towards the viewer to increase the reflections seen by the viewer and in so doing enhance the overall visual display aspect of the invention. This is not, however, necessary to achieve the desired effects.

Transducers and vibration speakers within the enclosure produce subwoofer like bass with vibrations heard and/or felt by the listener and normal speakers produce audio clarity and high fidelity when audio is listened to and viewed using the apparatus. The listener and viewer then feels the vibrations from the music, hears the audio with high clarity and simultaneously sees the frequency components, amplitude and tonal changes of the audio which produces an immersive experience.

In alternative embodiments, more or less audio visualization methods or display enclosures may be utilized. Other transparent and semi transparent electrolytes and conductive plate materials of varying properties, thicknesses and light refraction capabilities may be utilized for more controlled or manipulated charge/discharge cycles and different viewing or display conditions. A simple or complex grid of smaller conductive plates may also be utilized to produced a more controllable localized response in the objects which may produce better display characteristics.

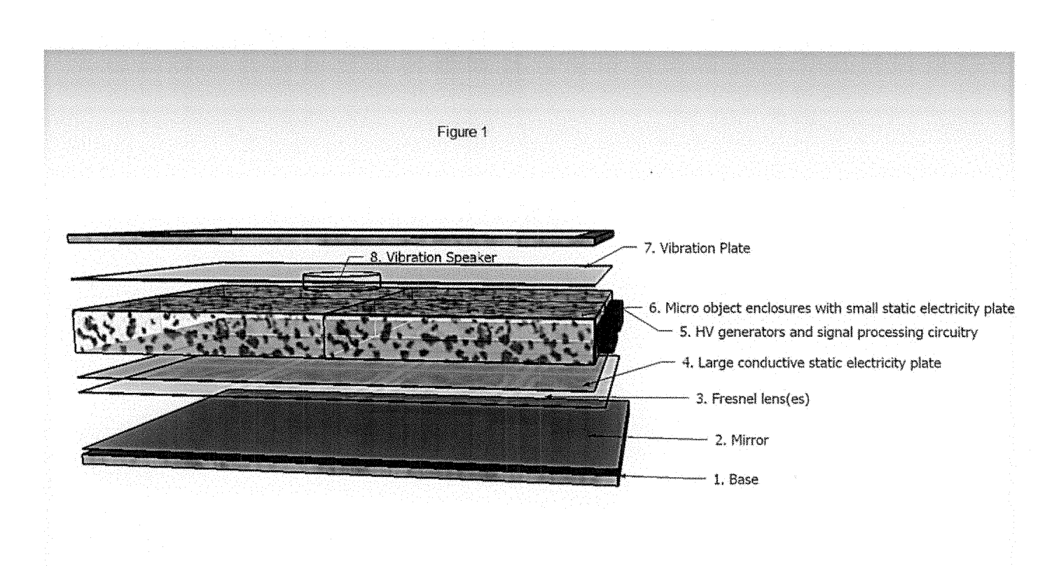

There is shown in FIG. 1 the mult-layered apparatus for displaying and radiating electromagnetic signals, esp. audio, to highlight particular characteristics of the signal in order that the visual perception of the signal or sound may be coupled with the auditory to provide a richer, more informative and more immersive user experience. The first layer labeled “1. Base” shows a wooden, preferably hollow base within which a number of speakers can be placed for high fidelity audio when necessary. Directly on top of the base is layer “2. Mirror” which in this embodiment, measures the same as the base 16″×20″.

The mirror is fastened and secured to the base using epoxy cement or resin of some kind. Above that labeled “3. Fresnel Lens” is a layer of four individual fresnel lenses to create 4 quadrants for the display of left, right, high and low tones and other signal characteristics. In one embodiment the lenses are made to swivel 1.5 to 2.5″ above the mirror for optimal focal distances and minimal holographic distortions when lenses move with control signal changes using the method as highlighted in Claim 2. About an inch above that layer is a “4. Large conductive transparent plate” of two sandwiched glass and/or plastic plates with a diluted hydrofluoric acid and/or stannous chloride electrolyte between them and an electrode connecting the electrolyte between the plates to an electrostatic source (not shown). Above item 4, the large conductive plate, and in-between the top conductive plates labeled as item 6 is the object enclosures. The electrostatic high voltage sources are labeled as item 5.

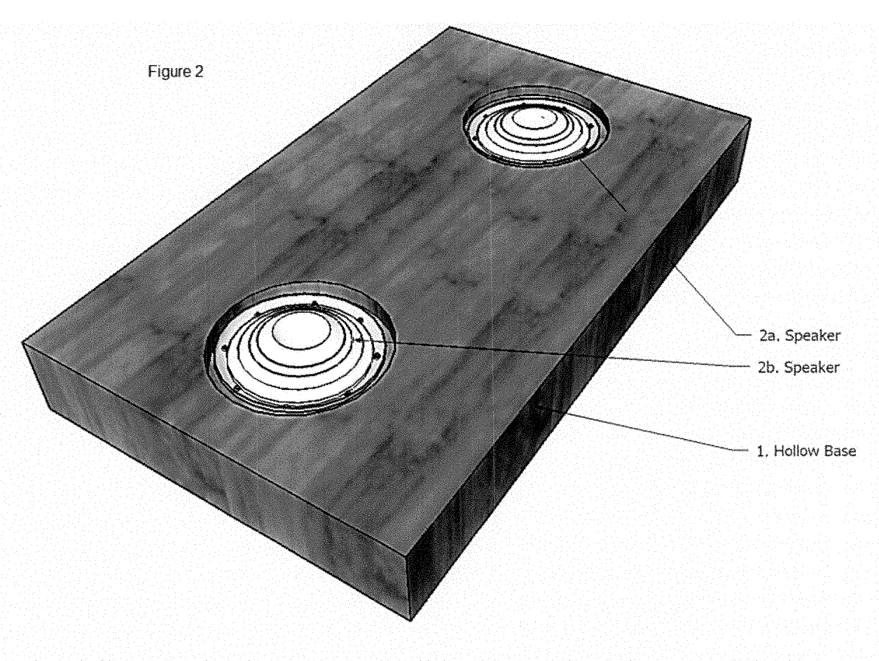

FIG. 2 shows a wooden base containing 2 speakers meant to indicate left and right channels and highlights why a hollow or semi hollow base is preferred. When the user listens to audio or music the majority of the sound they actually hear should come from these speakers, as opposed to the noises coming from the enclosures and vibration speaker connected to the transparent vibration plate. Other transducers placed within the apparatus are placed with consideration to noise canceling functions to hopefully reduce some of output noises from within the apparatus itself. More speakers can be used for greater audio fidelity, audio channels or simply for more power, however two 6″ speakers and a 25 W vibration transducer connected to the wooden base are used in this embodiment.

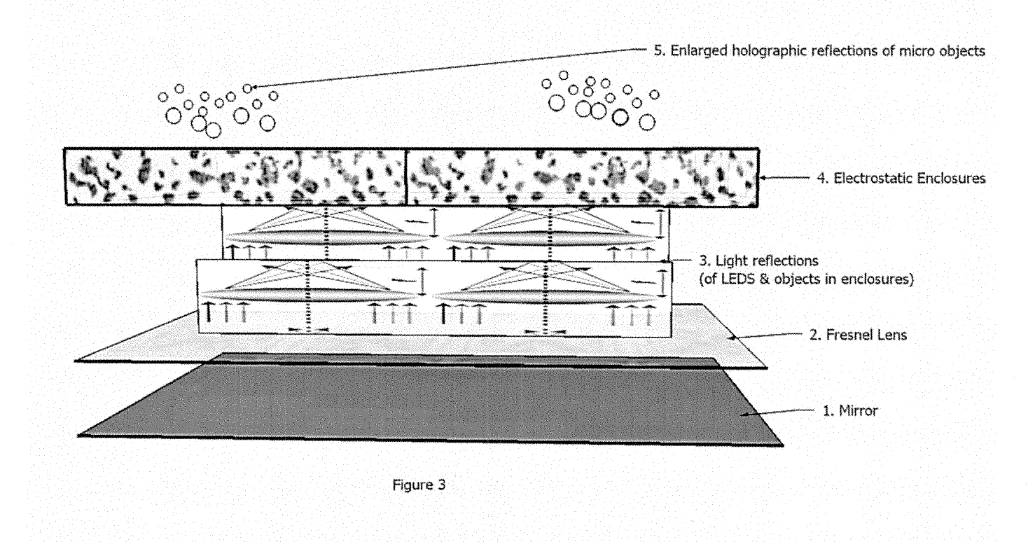

FIG. 3 attempts to illustrate the method by which objects within the apparatus are projected holographically above their display enclosures, shown as item 6, and the user is able to view them as mirror images floating above the real objects within the enclosures and moving opposite to them but with some magnification. An LED strip placed above and all around the display enclosures is the main source of light for the apparatus and so the objects will appear to change colors and their hologram reflections will flash and change colors. Light passes through the transparent enclosures then fresnel lens(es) down and is reflected back up through the fresnel lens then enclosures, shown as item 3, and magnified by them creating the illusion that the objects have more depth and appear closer to the viewer, who is above or to the side of the apparatus.

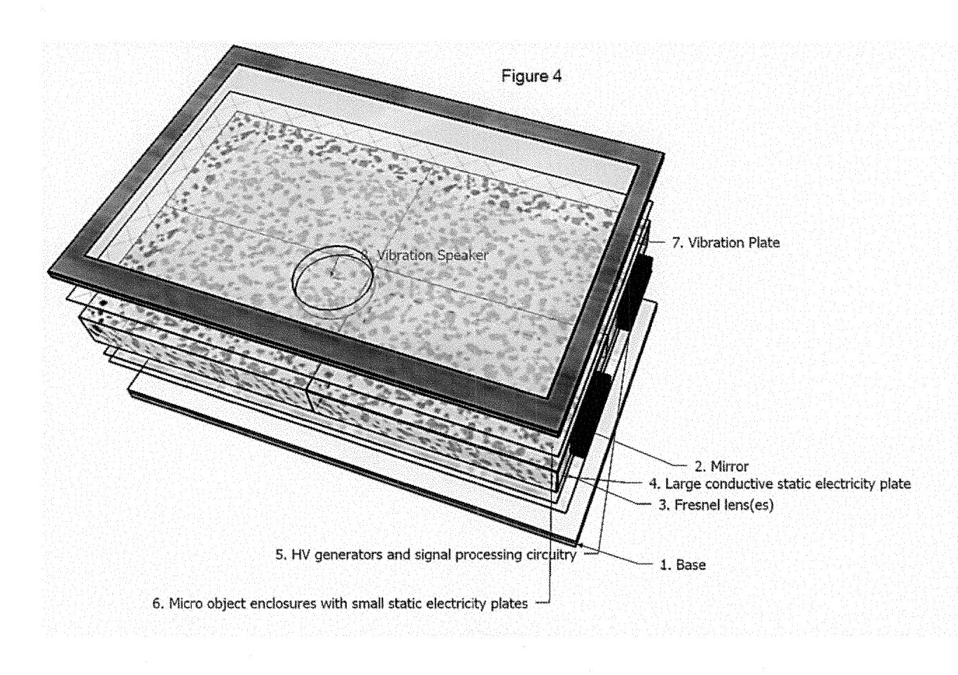

In FIG. 4 an overhead view of the apparatus without the holographic reflections is shown. The object layer is visible and the texture of the enclosure is meant to illustrate the objects within as they bounce around under the electrostatic charges and discharges created by item 5, the High Voltage (HV) generators or current sources. The Vibration plate layer, item 7, is not shown with a micro-bead substrate or cymatic geometric patterns upon it, for clarity, but in its normal working function the geometric patterns form above the enclosures and change in conjunction with the movements of objects and lights, thereby enhancing the visual display.

The High Voltage sources used generated over 80 kV using low current and were cycled on and off by circuitry controlled by an input electromagnetic signal. This signal is loaded into memory of a IC controlled sound module via bluetooth or WiFi, amplified and run through low pass filter for cycling the HV sources with frequencies lower than 500 Hz like the drum and kick instruments in music. With audio or music one enclosure handles left channel low frequency with larger objects and another left channel mid frequency with small objects. Two enclosures also represent the right channel audio in this manner. The transducers used for the vibration plate were 20 to 25 W and in this embodiment were fed signals in the 500 to 2000 Hz range to highlight tonal changes or instruments and vocals. These ranges can be tuned by the user along with the intensity or amplitude of the display.

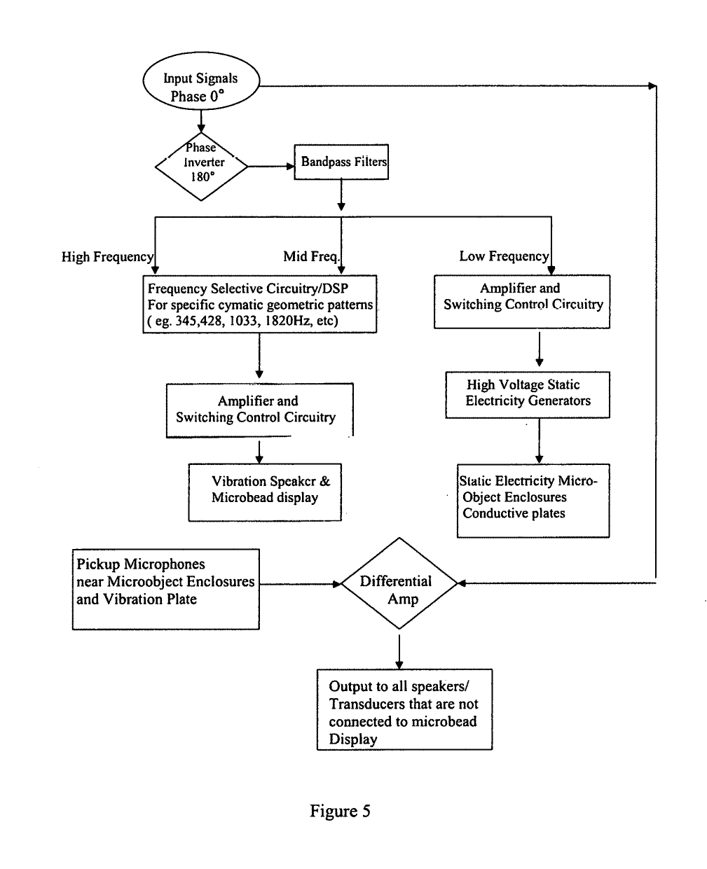

FIG. 5 is a flowchart detailing one system topology of the apparatus described by this invention. As shown, electromagnetic signals, e.g. audio, enters the system and is phase inverted for one path and sent through bandpass filters and amplifiers for frequency ranges 50-500 Hz (Low Freq), 500-2000 Hz (Mid) and greater than 2000 Hz (High). Phase inversion can be done before or after the bandpass filters stage. The low frequency components of the signal are amplified and used to drive the high voltage transformers connected to the electrostatic object enclosures, the light strip(s) which are placed in close enough proximity to the enclosures to be influenced by the pulses and the electrostatically controlled fresnel lenses. The mid and high frequences are sent through other frequency selective filters which are used to further limit the input signal frequency components radiated out from the vibration speaker to fundamental frequencies to display mainly those frequencies only on the vibration plate on which the substrate of amaranth or similarly performing micro-beads is placed. This allows for a slower transition between tones and fundamental frequencies and their harmonics being displayed and makes for a more defined and clear cymatic display.

Microphones can be placed within the enclosures, whose objects and beads generate sounds which may interfere with the original audio and this ambient noise is fed into a differential amplifier along with the original input signal. The differentiated signal is what is fed into normal speakers of the system to help eliminate noise out of the system the inverse noise signal is added into the original signal but with a 180 deg phase inversion. Feedback is used to manage the automatic gain of the final differential amp to maintain a good noise to signal ratio and overall output amplitude.

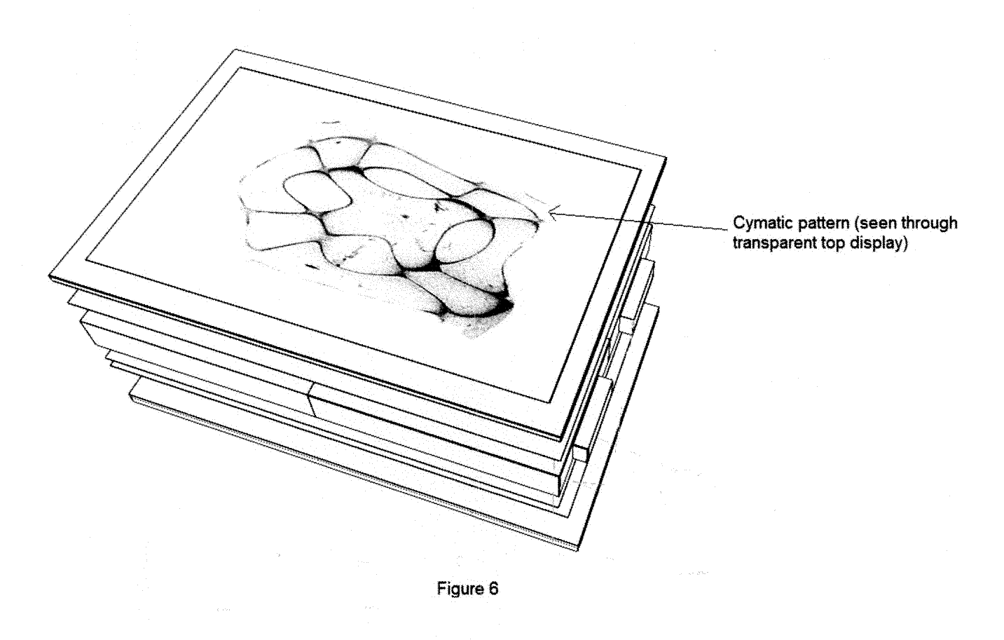

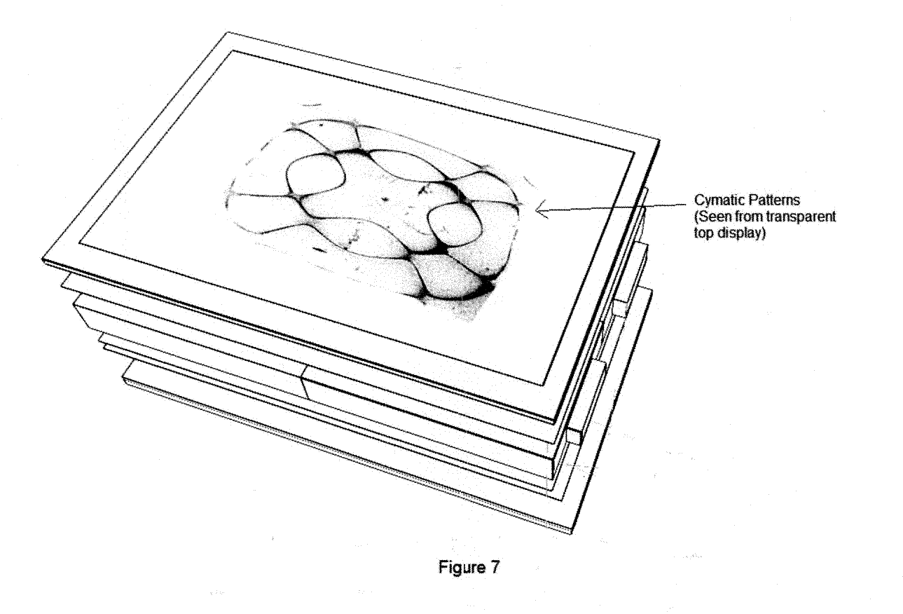

FIG. 6 and FIG. 7 shows examples of the cymatic geometric patterns displayed for certain fundamental frequencies on the transparent vibration plate within the substrate of amaranth or other micro-beads.

Although specific features of this invention are shown in some drawings and not others, each feature may be combined with any or all of the other features in accordance with the invention.

Other embodiments will occur to those skilled in the art and are within the following claims:

What is claimed is:

1. An apparatus to facilitate the visual representation of electromagnetic signals, both audible and inaudible, preferably comprising of a component for radiating sound or music, if any, and necessarily comprising of at least one component for producing a visual display which is directly influenced by inputted electromagnetic signals enabling this apparatus to serve as an acoustic visual display and speaker system for radiating sound and displaying standing resonant waveforms and signal patterns using a plurality of the visualization display methods, as described in this invention, typically 2 or more, including a vibration speaker/transducer and transparent vibration plate with a micro-bead substrate, high voltage electrostatic enclosures containing objects and/or light strips which are both controlled utilizing high voltage electrostatic discharges; displayed simultaneously, individually or in any combination, which when coupled with the audio of the electromagnetic signal provides a unique and immersive sound listening experience for the listener/viewer.

2. A method for using an electromagnetic signal, especially audio, to control high voltage static electricity, lights, sound pressure waves and/or vibration energy to radiate and/or display these electromagnetic signals, utilizing charge accepting materials that can be made to move in correlation with the control signal.

3. A method for utilizing control of high voltage static electricity as described in claim 2 to manipulate micro-spheres, beads and various other charge carrying or charge accepting surfaces or entire objects and also particulate materials of varying sizes, with varying physical and chemical properties to hover, bounce, move latitudinally, longitudinally or otherwise in one or more enclosures within the device or in any alternative design embodiment using the method, in conjunction with and to the rhythm or cadence, if any exist, of the electromagnetic input signals.

4. An apparatus as described in claim 1 which enables a user to hear and also visualize any audio signal they wish to, on demand, by controlling the device through a Bluetooth, wifi or similar connection interface from a smart device, laptop or any other electronic device, whether programmable or not.

5. A method of utilizing controlled static electricity as described in claim 2 to move a freely or somewhat freely suspended light strip with a series of static electricity pulses (electrostatic discharges) which pushes and pulls the strip to varying degrees, while the strip is comprised of or connected to charge accepting material(s) causing the strip to undulate, vibrate or shake with applied electrostatic forces and creates undulations of the light patterns produced by the strip, which may or may not flash, flicker and change colors or be reflected or focused by lenses, in correlation with the input signal frequency, amplitude, phase, rhythm or tempo changes.

6. As described in claim 5 light displays can be controlled by this method to additionally vibrate and waver when the light strip wavers with the vibrations of the speaker or transducer/exciter on the vibration plate, which the strip can be connected to via springs or other material, adding to the movement generated by the vibration plate as its also pushed and pulled with pulses of static electricity. Lights may also flash with the audio signal changes and may also be projected in a 3 dimensional visualization utilizing fresnel lenses and a reflective mirror system to project the light patterns above the top display panel.

7. A method of creating transparent conductive plates of any shape out of two bonded, joined, or otherwise sealed transparent sides, preferably but not necessarily of identical shape size and cut, joined around the edges with transparent epoxy or utilizing similar bonding agent, or sufficiently effective technique, to securely fasten the plates together, with an empty space or gap or plurality of spaces between them, in order to place a transparent electrolyte solution with little to no opaqueness in between the two plates to create a conductive layer to which an electrode or a series of electrodes and/or electrical connections are attached to establish connection to a current source or sources, esp but not limited to high voltage, in order to control and/or interact with the electric or electrostatic environment created around the surfaces of the plates.

8. An apparatus as described in claim 1 for displaying the effects of sound pressure waves and/or high voltage ionizing/static electricity, utilizing audible or inaudible, structured or random frequencies of electromagnetic signals as a modulated or non modulated input which drives lights, micro-beads/micro-spheres/objects or particulate substrates to move in order to demonstrate the patterns of these signals in a scientific, artistic, entertainment, vehicle, home, school, business or industrial display device or any derived applications thereof.

9. A apparatus as described in claim 1 which utilizes a speaker, transducer or exciter and a transparent vibration plate made of 0.010 mm to 1.5 mm thick glass, acrylic, polycarbonate, petg, plastic or any other material which is transparent and has some level of elasticity, flexibility or vibrational conductivity in order to display geometric cymatic patterns within a substrate of powders, micro-beads or objects placed on top of the plate, from electromechanical vibration energy or sound pressure waves, as with a Chladni plate, but where it is necessary for light to pass through the plate.

10. An apparatus, as in claim 1, which is comprised of and utilizes one or more exciters/transducers or vibration speakers, a transparent vibration plate connected to the speaker's electromagnetically movable coil in order to transfer vibration energy from the speaker coil to the vibration plate, radiating sound pressure waves throughout the connected plate in order to create ripples and standing waves in the transparent vibration plate, on top of which powders, micro-beads, or objects are placed and acted upon by the radiating sound pressure waves, thereby demonstrating the actual changing geometric structures of the audio signals, with patterns of changing nodes and anti-nodes displayed in real time, esp of fundamental frequencies, and with the input signal fully controlled by a user wirelessly or through line input.

11. An apparatus as described in claim 1 which utilizes either plain, non reflective or reflective, neon, glow in the dark, ultraviolet or translucent micro-beads, micro-spheres or any shape light weight materials with low density or using inks or paints to dye non colored materials to enhance the reflections of light and produce a more colorful representation of the electromagnetic signals, including audio, displayed within a micro-bead, micro-sphere, object, or particulate display system as described by this invention.

12. An apparatus utilizing the methodology described in claim 2 which shows electromagnetic cymatic signal structures or signal timing and/or tempo utilizing a high voltage electrostatically charged and discharged display case of micro-beads, eg. polystyrene or other similar lightweight beads, pellets or small light objects with positive or negative triboelectric affinity like pith ball micro-spheres or uniform and non uniform shaped objects which can be made to jump up, down, side to side and hover in a fully transparent display or multiple displays.

13. A means for using an electromagnetic signal(eg. audio) as described in FIG. 5 to control static electricity, lights, sound waves and vibration energy to radiate and display sound in correlation to the control signal that it may be interpreted by the auditory, visual and vibratory awareness senses simultaneously leading to a richer and more immersive sound listening experience.

14. An apparatus, utilizing the methodology of claim 2, which may be used as a musical instrument when, for example, micro-beads and other objects bounce up, down and sideways in the controlled static environment enclosures, whether transparent or not, controlled by an input siyrial, these objects tend to produce sounds which may add to music being played at the same rhythm or provide their own unique sounds similar to a marimba when, for example, utilizing plastic or polystyrene beads and like a steel drum or even a high-hat utilizing metal beads.

15. An apparatus as described in claim 1, which utilizes amaranth seeds, plastic or polystyrene pellets as a particulate, micro-bead, or mixed object substrate placed upon a transparent vibration plate or within an enclosure for the purpose of an electro acoustic display, volumetric display or musical instrument.

16. An apparatus as in claim 1 which uses frequency selective circuitry or digital signal processing but which selectively dampens particular preset or user selected frequency ranges and in so doing tunes out various instruments, voice tones or otherwise audible and inaudible tones out of user inputted audio, music or other electromagnetic signal, especially for the purpose of creating a more coherent and visually pleasing display.

17. A means for creating transparent conductive plates, as described in claim 7, of any shape out of two bonded, joined, or otherwise sealed transparent sides, preferably but not necessarily of identical shape size and cut, joined around the edges or as necessary, to securely fasten the plates together, with an empty space, gap or plurality of spaces between them, in order to place a transparent electrolyte solution with little to no opaqueness in between the two plates to create a conductive, sandwiched layer to which an electrode or a series of electrodes and/or electrical connections are attached to establish connection to a current source or sources, esp but not limited to high voltage, in order to control and/or interact with the electrical or electrostatic environment created around the surfaces of the plates.

18. A means for providing localized control of the movements of charge accepting and charge conducting materials, using an electromagnetic signal to control electrostatic energy discharges capable of affecting materials with a non-zero triboelectric affinity value, for example, conductive or charge accepting surfaces or structures made of glass, acrylic, polycarbonate, plastic, aluminum, copper, iron, etc.

19. An apparatus as described in claim 1 which projects holograms within and above display enclosures using one or more mirrors below the enclosures and fresnel lens(es) placed above the mirror(s) but below the enclosure(s) as well, which have transparent top and bottom surfaces for light to pass through, in order to produce seemingly 3D projected reflections when objects from above are reflected by the mirror, through the fresnel lens as holograms which seem to float above, below, or beside the objects themselves. Objects can be enlarged and projected above the enclosure and even the top display panel itself with the aforementioned 3D projection/reflection created by the fresnel lens and mirror by changing the distance of the fresnel lens from the mirror using the electrostatic control method described by this invention .

20. A means as described by claim 18 to provide localized, controlled distance and focal length changes of fresnel lenses or any lenses or mirrors in photography, film, 3d holographic projection, or any other 3D holographic application and also any application involving making visible and audible the spoken word or displaying characteristics of electromagnetic signals.
